(19) United States
(12) Patent Application Publication
(10) Pub. No.: US 2014/0035949 A1
(43) Pub. Date: Feb. 6, 2014

(54) METHOD AND APPARATUS FOR ENHANCING A CALENDAR VIEW ON A DEVICE

(71) Applicants: RAJAN SINGH, San Jose, CA (US); THIERRY DONNEAU-GOLENCER, Menlo Park, CA (US); COREY HULEN, Patterson, CA (US); MADHAV VAIDYANATHAN, Sunnyvale, CA (US); SCOTT BISHEL, Erie, CO (US)

(72) Inventors: RAJAN SINGH, San Jose, CA (US); THIERRY DONNEAU-GOLENCER, Menlo Park, CA (US); COREY HULEN, Patterson, CA (US); MADHAV VAIDYANATHAN, Sunnyvale, CA (US); SCOTT BISHEL, Erie, CO (US)

(73) Assignee: TEMPO AI, INC., Menlo Park, CA (US)

(21) Appl. No.: 13/566,476

(22) Filed: Aug. 3, 2012

(51) Int. Cl. G09G 5/00; G09G 5/377

(52) U.S. Cl. 345/629; 345/619

(57) ABSTRACT

An apparatus and computer-implemented method for enhancing a calendar view on a device comprising extracting data from a user's linked data store, processing the data to recognize one or more entities within the data, inferring correlations between the entities, supplementing existing calendar entries on the user's device with the inferred correlations, creating new entities and displaying one or more actions to the user based on the context of a selected calendar entry.

### BACKGROUND

1. Field of the Invention

Embodiments of the present invention generally relate to appointment, meeting management and scheduling applications, and more specifically to a method and apparatus for enhancing a calendar view on a device.

2. Description of the Related Art

Computing devices are often used for scheduling meetings, entering events into a calendar application, adding tasks to a to-do list and the like. Users often use computing devices to view calendar and meeting entries which may have been created on the same device or a different device. These activities are stored in either local databases or remote databases, otherwise referred to as cloud storage. Often times, the data is synched to a web-based calendar such as Google Calendar, Exchange Calendars, Hotmail®, Yahoo® or AOL Calendar. Often, these calendar events are incomplete or are not actionable, and crucial details about the meeting place, time, flight details, call-in details, agendas, documents, event attendees and other information are often left out of the description entered into the calendar application or not easily actionable into common daily workflows such as contacting the attendees, viewing the attendees LinkedIn® or Facebook®, getting driving directions, opening Yelp®, requesting a taxi, checking the flight status, buying flowers and so forth. Later, the user must sift through various emails, text messages, voice mails, documents and the like to extract important details related to the event, resulting in wasted time and effort. In some instances, calendar entries may not be formatted correctly making it difficult for a user to ascertain important meeting details.

Further, the user must shuffle between several mobile applications to execute common workflows. For example, if one of the attendees is late to the meeting, the user may have to shuffle to his address book to find the attendees phone number or email or let the attendee know that he/she is running late. In another instance, if there is confusion regarding the exact meeting location, the user may have to shuffle to FourSquare®, Yelp® or Google Maps® to search for the location to then navigate. Another common example are meeting notes and agendas that are compiled, but difficult to share since they must be attached to an email, uploaded to a file sharing website, or shared physically; the user in this instance may have to search his email or other folders. Other examples include searching for the flight status in a flight tracking application or having to remember the PIN number to dial-into a conference call. There are numerous other examples detailed below.

Therefore, there exists a need to provide a method and apparatus for enhancing a calendar view on a device.

### SUMMARY OF THE INVENTION

An apparatus and/or method for enhancing a calendar view on a device, substantially as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a computing device for implementing a method for enhancing a calendar view on a device in accordance with exemplary embodiments of the present invention;

FIG. 2A depicts a functional block diagram of a method for enhancing a calendar view on a device in accordance with exemplary embodiments of the present invention;

FIG. 2B illustrates the on-boarding process in accordance with exemplary embodiments of the present invention;

FIG. 2C illustrates various screens presented to the user in accordance with exemplary embodiments of the present invention;

FIG. 2D illustrates various cards displayed to a user in accordance with exemplary embodiments of the present invention;

FIG. 2E illustrates a functional diagram for connecting to and processing various data sources in accordance with exemplary embodiments of the present invention;

FIG. 3 depicts a flow diagram of a method for enhancing a calendar view on a device by sharing data in accordance with exemplary embodiments of the present invention;

FIG. 4A depicts a flow diagram of a method for adding calendar entries in a mobile device in accordance with exemplary embodiments of the present invention;

FIG. 4B depicts a flow diagram of a method for enhancing a calendar view on a device in accordance with exemplary embodiments of the present invention;

FIG. 5 depicts a flow diagram of a method for indexing and processing data on a mobile device in accordance with exemplary embodiments of the present invention;

FIG. 6 depicts a flow diagram of the method for determining primarily and secondarily important correlations on a mobile device in accordance with exemplary embodiments of the present invention;

FIG. 7 is an illustration of the application enhancement module enhancing calendar data in accordance with exemplary embodiments of the present invention;

FIG. 9 is an illustration of an action bar component in a user interface of the computing device implementation of FIG. 1 in accordance with exemplary embodiments of the present invention;

FIG. 10 is an illustration of overlapping day views of the user interface in the computing device implementation of FIG. 1 in accordance with exemplary embodiments of the present invention; and

FIG. 11 is an illustration of an alternate week view of the user interface in the computing device implementation of FIG. 1 in accordance with exemplary embodiments of the present invention.

### DETAILED DESCRIPTION

As explained further below, various embodiments of the invention disclose a method and apparatus for enhancing and making actionable a calendar view on a device in accordance with exemplary embodiments of the present invention. The method harvests and indexes a user's data store, including data from a mobile device, personal computer, personal cloud, and the like and enhances existing calendar entries with contextual information such as attendees, location, time and associates actions such as obtaining directions to the location, calling attendees and the like with the entries. In addition, the method infers the creation of new entities, such as calendar entries, based on the user's data.

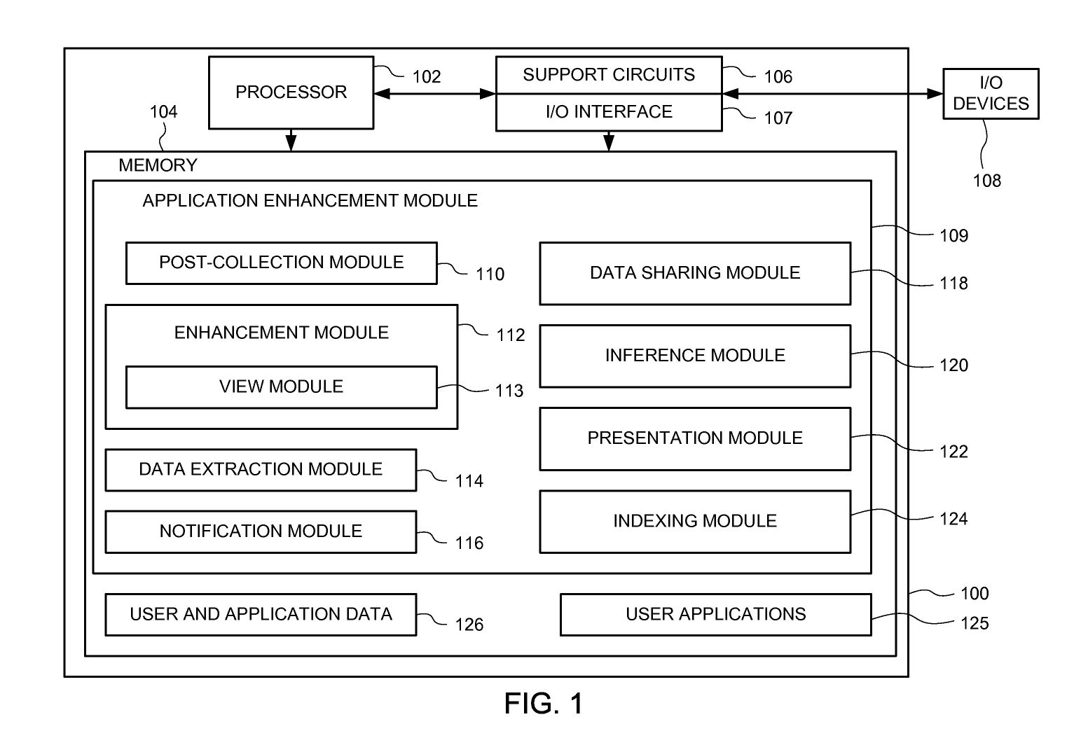

FIG. 1 depicts a computer 100 for implementing a method for enhancing a calendar view on a device in accordance with exemplary embodiments of the present invention. The computer 100 comprises a central processing unit (CPU) 102, support circuits 106, and memory 104. The computer 100 is a type of computing device (e.g., a laptop, a desktop, a notebook, a gaming device, a handheld device, mobile device, other electronic device and/or the like) known to one of ordinary skill in the art. The CPU 102 may comprise one or more commercially available microprocessors or microcontrollers that facilitate data processing and storage. The various support circuits 106 facilitate the operation of the CPU 104 and include one or more clock circuits, power supplies, cache, input/output circuits, displays, and the like. The memory 108 comprises at least one of Read Only Memory (ROM), Random Access Memory (RAM), disk drive storage, optical storage, removable storage and/or the like, but excludes transitory media.

The memory 104 stores processor-executable instructions and/or data that may be executed by and/or used by the processor 102. These processor-executable instructions may comprise firmware, software, and the like, or some combination thereof. Modules having processor-executable instructions that are stored in the memory 104 comprise the application enhancement module 109. The application enhancement module 109 comprises the post collection module 110, the enhancement module 112, the data extraction module 114, the notification module 116, the data sharing module 118, the inference module 120, the presentation module 122 and the indexing module 124. The enhancement module 112 further comprises a view module 113. User and application data 126 and user applications 125 also reside in memory 104. Execution of the instructions by the processor forms an apparatus (a module) for performing the function defined by the instructions. In an exemplary embodiment, the memory 104 may include one or more of the following: random access memory, read only memory, magneto-resistive read/write memory, optical read/write memory, cache memory, magnetic read/write memory, and the like, as well as signal-bearing media, not including non-transitory signals such as carrier waves and the like.

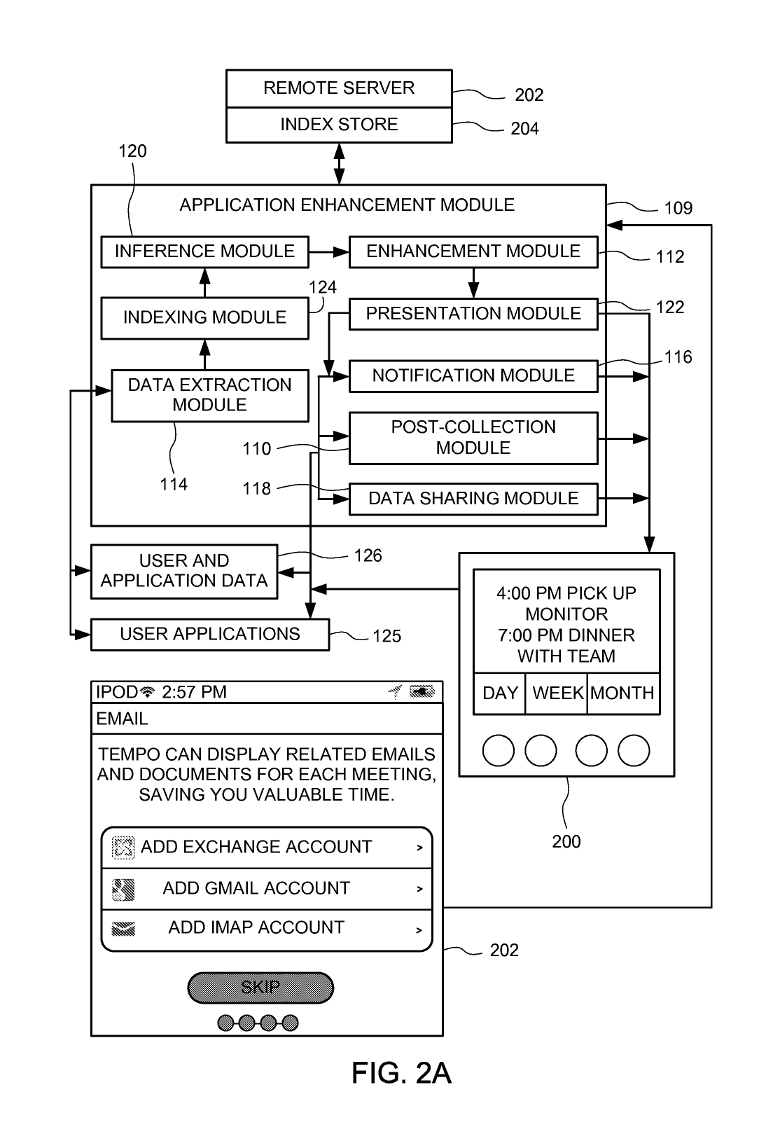

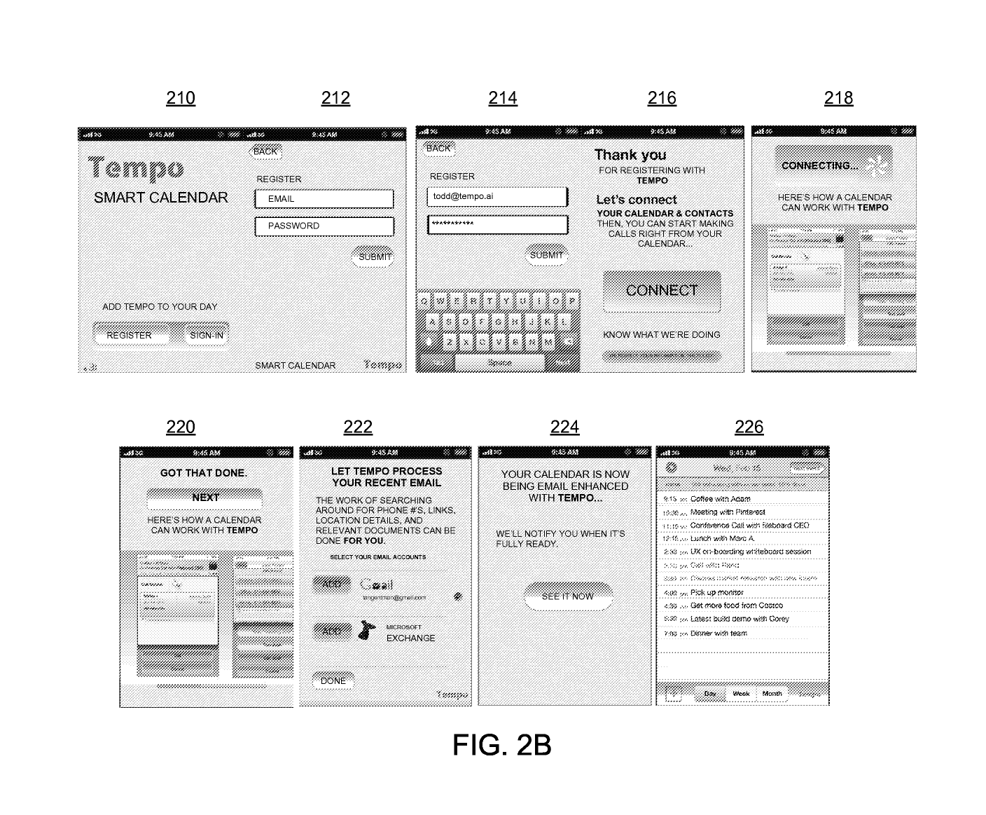

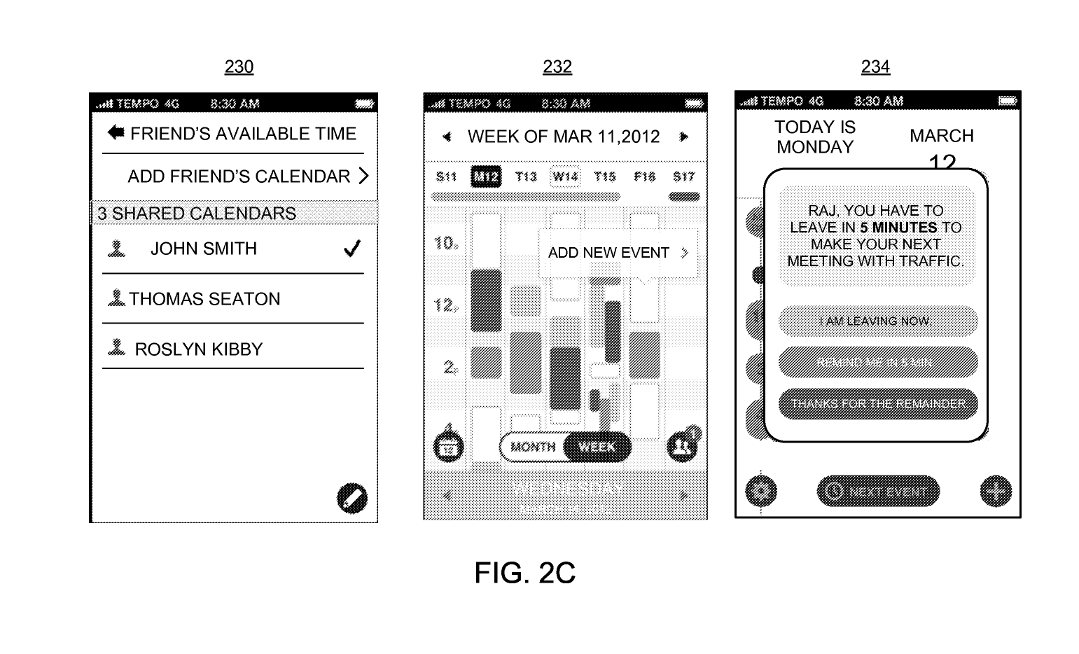

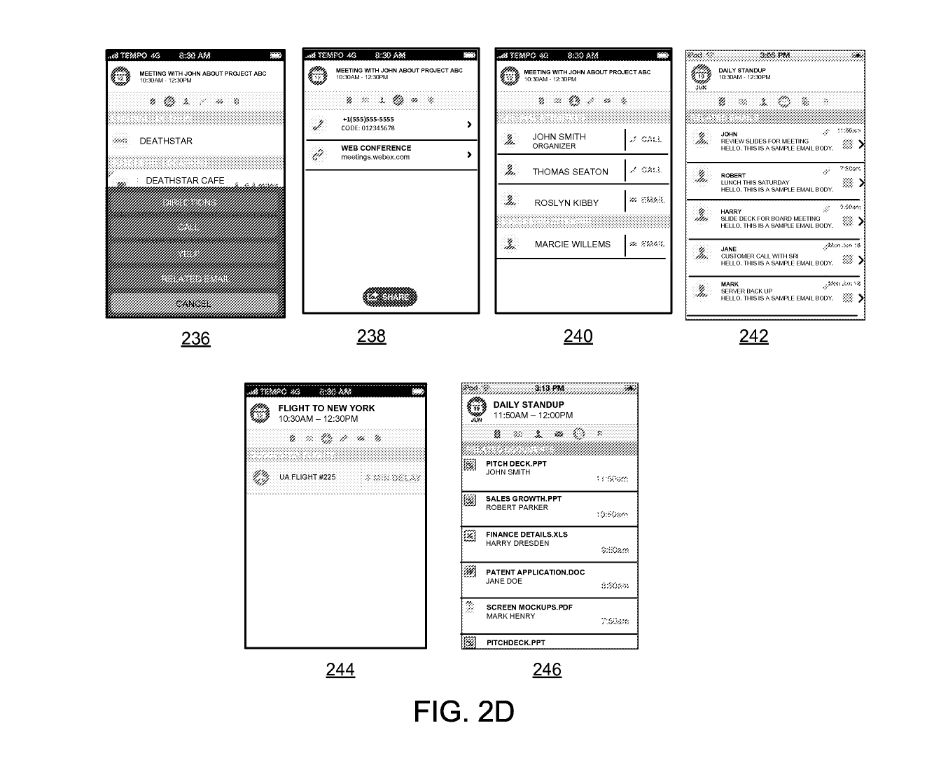

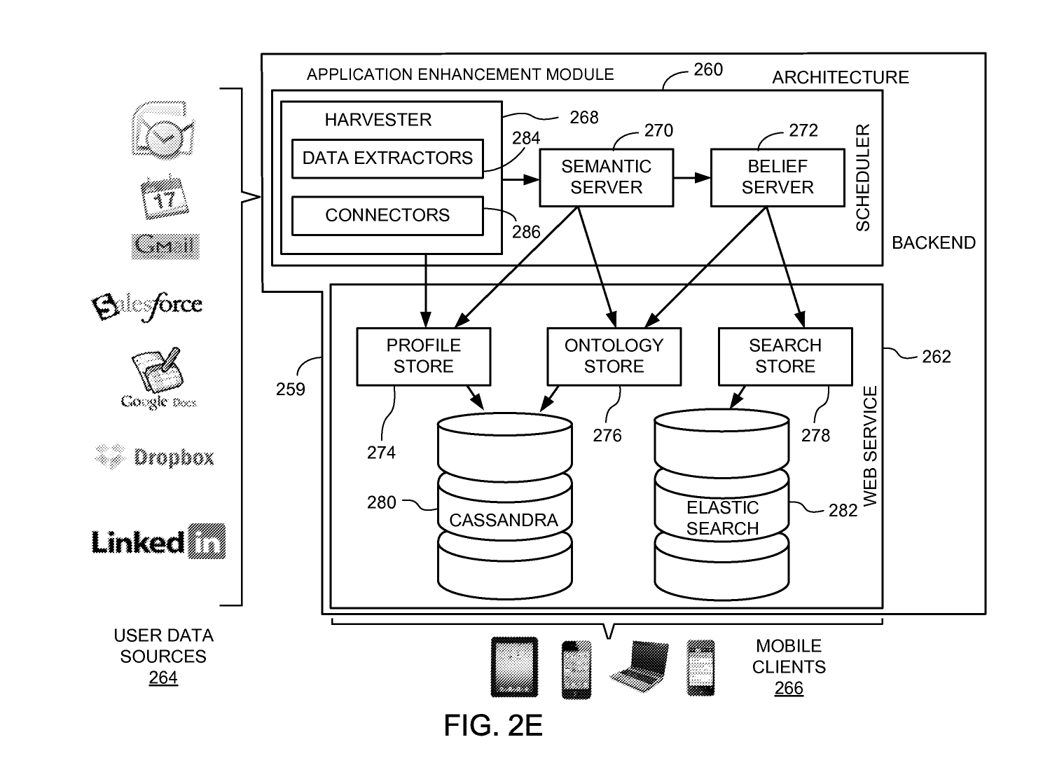

FIG. 2A depicts a functional block diagram of an apparatus for enhancing a calendar view on a device in accordance with exemplary embodiments of the present invention. FIG. 2 depicts the interaction between the modules in computer 100 to produce an enhanced application view on mobile device 200. A user stores calendar and contact data on a device 200 as user and application data 126. Alternatively, the data can be stored remotely in a cloud storage service or the like, for example, remote calendars such as those provided by Google®, Yahoo®, AOL, Hotmail, Microsoft® Exchange, or by the enterprise, e.g. via an on-premises Microsoft Exchange Server or Hosted Exchange Server. The application enhancement module 109 uses the data extraction module 114 to extract data from the user and application data 126. The application enhancement module (AEM) 109 also extracts information regarding user applications 125, such as call log information and the like. In some embodiments, the applications 125 are explicitly coupled to the module 109 and data is only extracted from the coupled applications. Examples of applications which can be interfaced include Dropbox®, Evernote, LinkedIn, Salesforce® and the like.

According to one embodiment of the present invention, a process called “on-boarding”, as shown by the view 202 and, in more detail, in FIG. 2B, begins with registering or signing-in with the AEM 109 as shown in view 210, 212 and 214. In view 216, a user has logged in and is ready to connect various internal and external data sources, including public data sources, to his account. The indexing module 124 processes all the data 126, which involves, for example, indexing the data, determining if a user has connected his or her calendar to particular hosting providers (or the local device) such as Microsoft Exchange® or Gmail®, and the like as shown in views 216, 218, 220, 222 and 224. The indexing module 124 further processes entries in a user's address book/contact list, and/or any other data source that the user may connect (e.g. cloud sources like Evernote and other local resources like Photos, SMS and potentially even their desktop via the cloud). The indexing module 124 differentiates whether the entry is a local device contact or a network synced contact from social networking sites or the like. Each contact's email address, job title, telephone numbers and other details are indexed and duplicates are virtually merged. Contacts may also be extracted and merged from other sources the user may connect to, such as contacts from email signatures, Salesforce® and so forth. Once the on-boarding process is complete, in one embodiment, an enhanced calendar view 226 is shown to the user.

The on-boarding process also accounts for whether a particular calendar already exists in the data 126, which calendars are selected for viewing and which are not displayed. The locale and time zone of the device is determined for language settings by the data extraction module 114. The language dictates how and which semantic indexing and processing is performed, i.e., different semantic methods are used for different languages.

SMS information, photos, browsing history and other data sensors are also extracted to perform future communication heuristics and semantic analysis. If the user permits, additional cloud sources such as the user's email data are also indexed, where the processing takes into account email senders, recipients, date, priority, attachments, read/unread state, whether the email is a reply, or an initiated email, length of response time, spam status, time clustering of the response (e.g., were the responses immediate, or separated by hours), content and the like. If the user permits, LinkedIn® is also indexed where the processing takes into account colleagues, job titles, companies, contact details and more. The data extraction module 114 and the indexing module 124 perform their extraction and processing as disclosed in U.S. patent application Ser. Nos. 13/287,985 and 13/287,983 both to Donneau-Golencer. According to another embodiment, user and calendar data is used for generating reports and drive discovery of patterns in a user or group of user's activities. Further, users are able to perform natural language searches using queries against their personal data, as disclosed in U.S. patent application Ser. No. 13/353,237 to Singh, and U.S. Pat. Nos. 6,742,021 and 6,523,061 to Halverson.

The indexing module 124 is coupled to the inference module 120. The inference module 120 infers correlations and entities from the extracted data 126 and entries for user applications 125, such as the Calendar application. For example, if the application is a calendar application, meeting entries are examined and it is determined based on the data 126 whether this meeting is a recurring meeting, whether it is an all day meeting, the location of the meeting, name of attendees and the like. The inference module 120 determines the intent and the purpose of a meeting and uses the intent as the basis for enhancement to the calendar view. Intent is determined via semantic analysis of the meeting data and various other signals from other related information provided by the user or from public data sources such as Weather.com, Hoovers, Yelp, FourSquare, LinkedIn (Public) and more. In one example heuristic, timestamps for sent and received email highly correlate to the last modified date of the calendar item. In one embodiment, based on the locale of the mobile device in use, using a positioning (GPS or similar) sensor, the location provides another signal couple with a location database, meeting density, frequent meeting locations and more to correctly correlate the event location information to the event entry. This information is collected from email data, contact data, time-stamped photographs, voicemail, browsing history, communication patterns, other meeting data and the like.

For example, if a user has a meeting entry for 4 PM on Saturday, the inference module 120 searches the user's indexed email data for any emails relating to the 4 PM Saturday meeting time. The email addresses in the email are one signal of possible attendees of the meeting. In some embodiments, signals also include, but are not limited to, content and topics of the emails, sent/received dates of the emails, subject of the emails, number of replies in the email thread, email domains, frequency of specific words, whether the email is a reply (or not), whether the email corresponds to a confirmed attendee, density of the email, specific keywords or grammar in the email, whether the emails are clustered and deemed related by a classifier, and whether those emails have attachments and what types of attachments.

The enhancement module 112 is used to create a new entry in the index store 204 correlated to the original calendar entry. The new entry created by the enhancement module 112 contains a link to the original calendar entry, as well as enhanced information such as the attendee list and their contact details. Other information inferred and correlated, for example, dial-in telephone numbers, location, agenda and the like, are attached as notes to the meeting entry. The inference module 120 performs semantic and topical analysis where inference and clustering/classification are used to correlate the information contained within the text of meta-data for emails, text messages and the like, as disclosed in U.S. patent application Ser. No. 13/149,319 to Donneau-Golencer.

Another example is when a user has a meeting entry titled “Meeting with John @ Nokia.” According to one embodiment of the present invention, the possible location is extracted via a series of signals including user's current location, user's last location, user's former location history, number of meetings in that user's day and estimated geo-proximity, user's location history within his domain (work) or those he interacts with whom are also Tempo users, If the location is semantically tagged as a possible location via a location database or other system, if the NLP analysis of the meeting description indicates that the description may be referencing a location, who the attendees are and what companies they represent, capitalization of places, if the location appears to be an abbreviation which is common or known from a location database, if the text of the location is cross-correlated among connected data sources, and the like.

In another meeting example, “Call with John” which happens to be a conference call, an embodiment of the present invention infers the conference call number through various signals such as typical conference call formats, semantic cues (e.g. code, PIN, moderator), previous dial-ins with these attendees and the like. In this instance, the dial-in is auto-dialed with the correct PIN automating a common day workflow.

Another meeting example is when the user creates a meeting “Coffee at Starbucks.” In one embodiment, the application enhancement module 109 recognizes the entry as a “destination meeting” and a one-to-one meeting versus a one to many meeting based on statistics regarding coffee-related events. The enhancement module 112 along with the presentation module 122 determines that the primary information to display is the location of the specific Starbucks as inferred from an email and/or via public web sources based on the user's location/home-base. In addition, the Starbucks could be augmented with simple actions to “Buy Coffee,” “Check-in,” “Call” and the like. The secondary information for the event may be the attendee's LinkedIn details and telephone number.

Another meeting example is when the user creates a meeting “Dinner with Wife.” In one embodiment, the application enhancement module 109 recognizes the entry as a personal event and determines that it is less likely the user will be interested in the attendees' LinkedIn information and that more likely the user is interested in venue information. If the inference module 120 determines the venue is a restaurant, the enhancement module 112 enhances the calendar entry with the menu of the restaurant, the ratings for the restaurant, telephone number for reservations, reviews on yelp, nearby parking spots and the like. The enhancement module 112 may also provide actions to the user, such as book a table on Open Table®, order on-line, rate on Yelp®, check-in to FourSquare, post to FB/Twitter® or the like, related to the particular venue.

In another embodiment of the present invention, the inference module 120 determines the current time of day and performs actions accordingly. For example, if the user engages his device in the morning, the presentation module 122 shows a summary of the user's day as well as relevant news related to the meetings that have been semantically identified for later in the day. According to one embodiment, the application enhancement module 109 reads the day's full or summarized details aloud to the user. Another type of contextually timed event is a one on one meeting with the user's manager or an activity outside of work. The inferencing module 120 recognizes that the meeting is with the user's manager and the presentation module 122 presents the user with, for example, a summary of last week's accomplishments.

The presentation module 122 presents the enhanced calendar view to the user of the device 200. The enhanced view may be an overlay of an existing application such as a calendar application with added entries and/or added information, such as discussed above, to existing entries. Alternatively, the enhanced view may comprise a stand-alone application which reads data from the index store 104 and displays entries from the calendar and email data, but with additional information as discussed above. Presenting an enhanced view to the user also gives the user the ability to customize the application on how and what data the indexing module 124 and the inference module 120 act upon. Based on context inferred by the inference module 120, the enhancement module 112 determines the most appropriate set of information to display (i.e., cards to display) to the user.

The notification module 116 provides notifications to the user on what has changed, from a user's perspective, in the meeting since its creation, such as number of attendees, location, time or the like. If notes were taken at the meeting and attached to an enhanced application entry by one attendee of the meeting, the post-collection module 110 collects the notes and stores them in the index store 204 and correlates the notes with the original calendar entry, using a number of signals including timestamps, content and topics and the like. In alternative embodiments, other items such as related documents, photos, links and more can be correlated with the original calendar entry using similar signals and others. Optionally, the data sharing module 118 shares the notes or other data discussed in the meeting with the rest of the attendees, according to U.S. patent application Ser. No. 13/182,245 to Nitz, Ser. No. 12/632,491 to Donneau-Golencer and Ser. No. 12/538,475 to Berry. According to one embodiment, the data sharing module 118 emails each attendee the data acquired. In other embodiments, the data sharing module 118 stores the data in cloud storage such as Dropbox® or the like, updates the enhanced entry to link to the stored data, and/or performs in-app sharing where a “card” is enhanced and appears in other user's calendar application.

In yet another embodiment, the sharing module 118 allows the application enhancement module 109 to share data across user calendars and calendar systems. In one embodiment, specific data such as availability data as shown in FIG. 2C is stored in the user and application data 126 and shared by the data sharing module to either select users, LinkedIn, a domain, Facebook, an address book, or other contextual groups. According to one embodiment, sharing is transient (time restricted) or perpetual, and view privileges are limited to availability allowing for greater access to another user's calendar as shown in view 230 of FIG. 2C. Users can then overlay colleagues/friends availability onto their calendar via Week View or in a new enhanced Day View as shown in view 232 of FIG. 2C. In another embodiment, if users of different devices engaging the application enhancement module 109 are implicitly confirmed for a meeting entry, the data sharing module 118 determines that two meetings in different users' calendars semantically appear similar and the notification module 116 implicitly confirms the meeting and/or indicates presence without the meeting explicitly detailing each other user as an invitee or attendee.

FIG. 2D illustrates various cards displayed to a user in accordance with exemplary embodiments of the present invention. These cards are automatically generated by the enhancement module 112. In an exemplary embodiment, view 236 shows a location card with several associated actions. For a created, enhanced, or inferred calendar entry, the location card in view 236 is shown to a user, depicting a map of the venue determined to be the location of the meeting, traffic analysis and the like. Several associated actions are shown in the card such as “Open in Maps”, “Directions from Current Location” and “Nearby Parking Garages.”

View 238 is enhanced with a Conference Call card showing conference call details such as a bridge telephone number, access code and actions such as initiating the call and the like. View 240 shows an Attendee card showing attendees of a particular meeting and attendee details such as contact information, profile pictures, alternative methods of communication and the like. Many different types of cards can be shown, for example, a Related Documents card, Emails card, Flight/Travel card, Task card, Birthday card and the like. Each card would have contextually important associated actions accessible to the user. View 242 shows a related email card. The related email card in view 242 displays emails relevant to a particular meeting. Details of the emails such as participants, date of the email, and attachments are shown to a user. View 244 shows an exemplary implementation of a flight card for showing flight information to a user. View 246 shows an exemplary implementation of a document, or related document card. The user can view information about documents related to a meeting or the like. The user can also perform various related actions on these cards as shown in the illustration, such as, according to an exemplary embodiment, calling a restaurant, calling into a conference, contacting a meeting attendee, viewing an email thread, checking in a flight, or adding or deleting a related document.

FIG. 2E illustrates a functional diagram for connecting to and processing various data sources in accordance with exemplary embodiments of the present invention. According to an exemplary embodiment of the present invention, the application enhancement module 259 comprises a scheduler 260, coupled to a web service 262 both on the back end of a server. User data sources 264 are connected to the application enhancement module 259. Various clients (e.g. mobile clients such as phones, notebook computers, tablets and the like) secure a connection to the application enhancement module 259. The scheduler 260 comprises a harvester 268, a semantic server 270 and a belief server 272. The harvester 268 further comprises data extractors 284 and connectors 286. The connectors 286 perform the functional connection to the data sources 264 and the data extractors extract data from the various connected data sources 264.

The semantic server 270 performs semantic analysis on the data extracted by the data extractors 284. For example, the semantic server 270 analyzes a user's textual language exchanges between contacts to determine contextual meanings of certain phrases and the like. The belief server 272 extracts beliefs about the user and his or her contacts and activities from the extracted data. The web-service 262 comprises a profile store 274, ontology store 276 and a search store 278. The harvester 268 and the semantic server 270 are further coupled to the profile store 274. The Semantic server is also coupled to the ontology store 276. The belief server 272 is coupled to both the ontology store 276 and the search store 278. The profile store 274 and the ontology store 276 are coupled to the database 280, e.g., an Apache® Cassandra® database. The search store 278 is coupled to the database 282, e.g. a scalable search engine such as ElasticSearch®. The profile store 274 stores profiles of users connecting to the application enhancement module 259. The ontology store 276 stores adaptive ontology's as disclosed in co-related U.S. Patent Application Attorney Docket Number P6439, hereby incorporated by reference in its entirety. The search store 278 performs searches on various beliefs of the user to correlate users and beliefs.

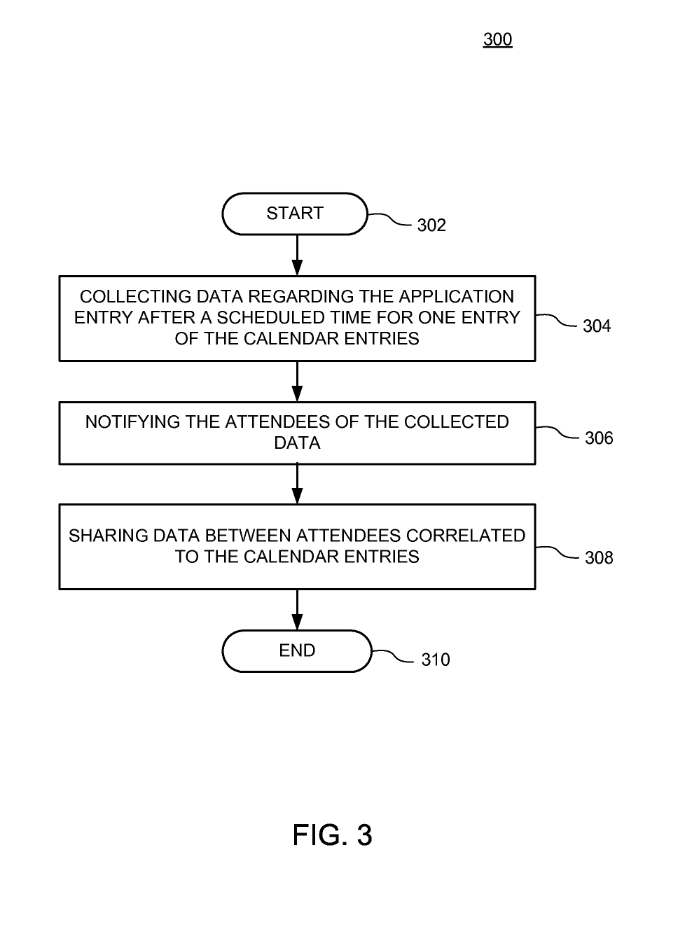

FIG. 3 depicts a flow diagram of a method 300 for enhancing a calendar view on a device by sharing data in accordance with exemplary embodiments of the present invention. The method 300 is an implementation of the inference module 109, the post collection module 110, the notification module 116 and data sharing module 118 as executed by processor 102 in the computer 100. The method begins at step 302 and proceeds to step 304.

At step 304, the method 300 collects data regarding an application entry after a scheduled time for one entry of the calendar entries. For example, if the method 300 determines that a time for the meeting has concluded, and there were notes or items generated during the meeting, these data items will be collected by the post collection module 110 by scouring the linked emails, cloud storage, and the like.

At step 306, attendees of the meeting will be notified of the collected data by the notification module 116. The notifications may also be of changed meeting times, or follow up meeting requests. The users may be notified through email, text messages, calendar entries in their personal calendar, or task requests through applications on the device. The notifications may also be of changed attendance in the meeting or of other pertinent data. The method then moves to step 308, where if data was collected, the data is shared amongst the attendees. If there are any contacts that were inferred to be required to be present, the data will also be shared with them through cloud storage, web links, emails or the like. The method 300 ends at step 310.

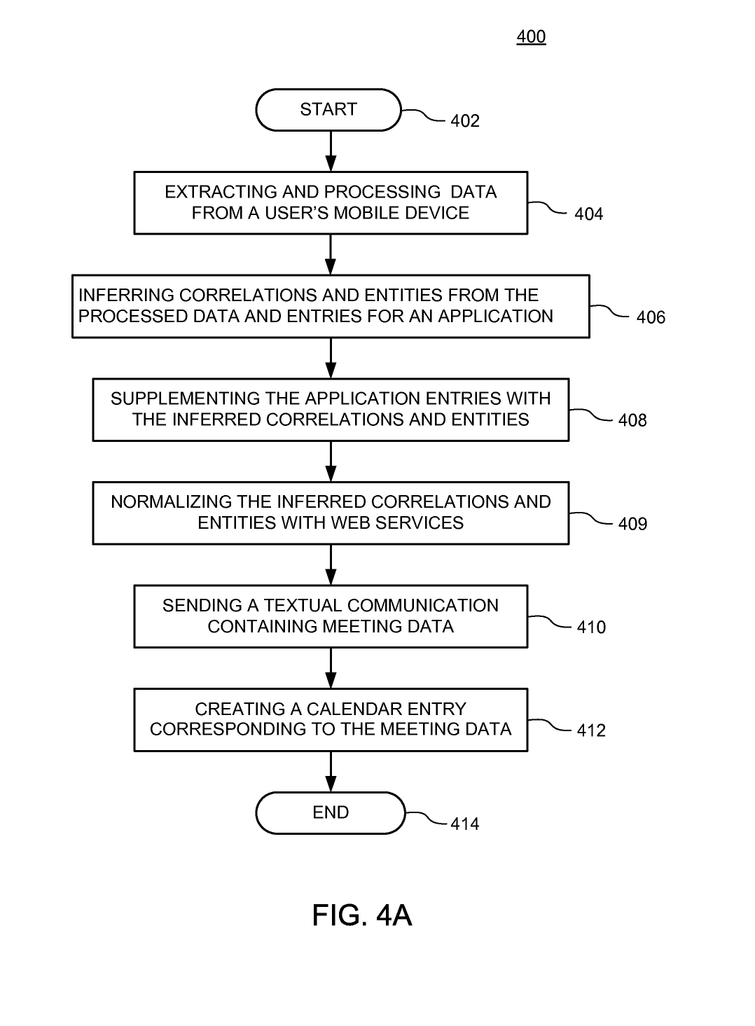

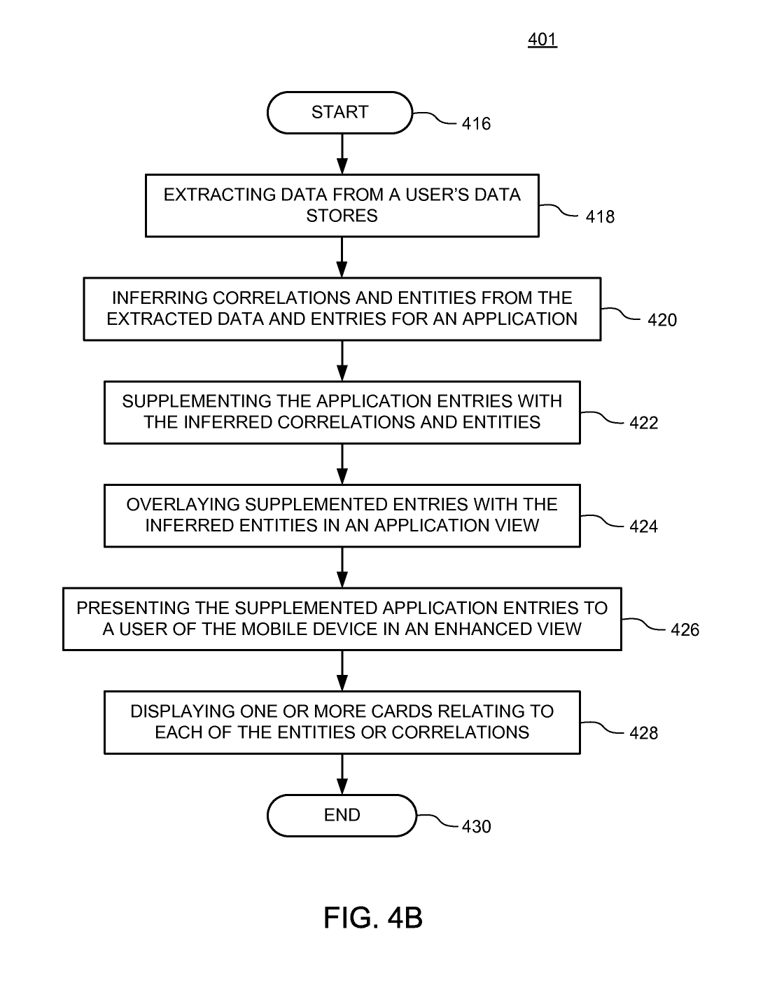

FIG. 4A depicts a flow diagram of a method 400 for adding calendar entries in a mobile device in accordance with exemplary embodiments of the present invention. The method 400 is an implementation of the application enhancement module 109 and specifically, the notification module 116, as executed by processor 102 in the computer 100. The method begins at step 402 and proceeds to step 404.

At step 404, the method extracts data from a user's mobile device. The extracted data includes application data such as emails, call logs, calendar entries, task lists, text messages, contact lists, online data and the like. The user is prompted initially to allow permission for the method 400 to access this data. The user also is able to customize which applications or types of data the method 400 can extract from the user's mobile device. The user can also control visibility of each calendar or data source displayed, independent of the data being indexed. The user can add additional data sources containing more information regarding the user and calendar entries, in order to facilitate improved functionality of the application enhancement module 109.

The method 400 then proceeds to step 406, where correlations and entities are inferred from the extracted data and entries for a set of applications. Using the previous example, if the applications consist of a calendar application, an email application and a contacts application, the inferring step 406 will, using the other signals previously mentioned, extract calendar entries, compare meeting times with those mentioned in emails, compare calendar entry subjects with the email subjects, extract the contact details of contacts as entities involved in the email thread, and the like. Further, the inferring step may involve determining the sender of the correlated emails to establish a further basis for semantic correlation. Frequency of emails, meetings or the like, with a particular contact is also stored by the method during this inferring step.

At step 408, the method supplements the application entries with the inferred correlations and entities from step 406. The inferred correlations and entities are stored in a data store, either local or remote to the mobile device and are linked to the original application entries. In the calendar example, the attendees, location, time and frequency of the meeting entry is stored in the data store and linked to the original calendar entry for the meeting, if there was one. If there were no original meeting entry, the data is linked to a particular date. In other instances, if the enhancement module 112 adds a virtual event to the calendar reminding the user, for example, to pick up food on the drive home, to buy groceries, or to set their DVR to record a particular television show based on learning acquired through the use of the application. The method then proceeds to step 409, where the inferred correlations and entities are normalized using web services.

At step 410, the notification module 116 optionally sends textual communication containing meeting data to recipients who are inferred as being attendees of a particular event. For example, a short message service (SMS) or an email is sent out to the attendees present and not present at the meeting. In addition, at step 412, the method creates a calendar entry corresponding to the meeting data. The method ends at step 414.

FIG. 4B depicts a flow diagram of a method 401 for enhancing a calendar view on a device in accordance with exemplary embodiments of the present invention. The method 401 is an implementation of the application enhancement module 109 as executed by processor 102 in the computer 100. The method begins at step 416 and proceeds to step 418.

At step 418, the method extracts data from a user's mobile device. The extracted data includes application data such as emails, call logs, calendar entries, task lists, text messages, contact lists, online data and the like. The user is prompted initially to allow permission for the method 401 to access this data. The user also is able to customize which applications or types of data the method 401 can extract from the user's mobile device. The user can also control visibility of each calendar or data source displayed, independent of the data being indexed. The user can add additional data sources such as particular web-sites and the like, containing more information regarding the user, in order to facilitate improved functionality of the application enhancement module 109. In other embodiments, data is extracted from other cloud services that the user has provided permission to access.

The method then proceeds to step 420, where correlations and entities are inferred from the extracted data and entries for a set of applications. Using the previous example, if the applications consist of a calendar application, an email application and a contacts application, the inferring step 420 will extract calendar entries, compare meeting times with those mentioned in emails, compare calendar entry subjects with the email subjects, extract the contact details of contacts as entities involved in the email thread, and the like. Further, the inferring step may involve determining the sender of the correlated emails to establish the host of the meeting, i.e., a further basis for semantic correlation. Frequency of emails, meetings or the like, with a particular contact is also stored by the method during this inferring step.

At step 422, the method supplements the application entries with the inferred correlations and entities from step 420. The inferred correlations and entities are stored in a data store, either local or remote to the mobile device and are linked to the original application entries. In the calendar example, the attendees, location, time and frequency of the meeting entry is stored in the data store and linked to the original calendar entry for the meeting, if there was one. If there was no original meeting entry, the data is linked to a particular date, or a new meeting entry is created.

At step 424, the method overlays the supplemented entries with the inferred entities and correlations in an application view either as an add-on to a user's calendar or as a standalone calendar application using the enhancement module 112. In one embodiment, the overlay constitutes a new application with an enhanced view showing the entries from the original application along with the correlations derived in step 420. The overlay is, for example, a highlighted entry whose importance has been increased because of the number of emails correlated to the entry, or the number of attendees in the meeting associated with the entry. At step 426, the method presents the supplemented application entries to a user of the mobile device in an enhanced view of the application. The presentation module 122 displays the enhanced view of the application, or a new application with an enhanced view on the screen of the mobile device. In one embodiment, the enhanced view is according to a determined time of day.

The method 401 proceeds to step 428, where after the enhanced view is displayed to the user, one or more “cards” are displayed to the user, relating to each of the entities or correlations, containing one or more items of detail regarding the entities or correlations. The cards are determined based on context, including location of the device, attendees of a meeting, time of the meeting, location of the meeting and the like. For example, cards can include information regarding location disambiguation, conference call disambiguation, attendee and corresponding contact or virtual card (vCard) disambiguation, related emails, documents and/or other meeting notes, Salesforce® information, flight status information, restaurant menus, event/conference agendas, summary of previous weeks work for a manager meeting, top priority items, summary of your day in the morning and/or at night and the like. In some embodiments, information displayed on each card is potentially actionable, i.e., a user may perform some actions related to the information displayed in the card. The method proceeds to step 430, where the method ends.

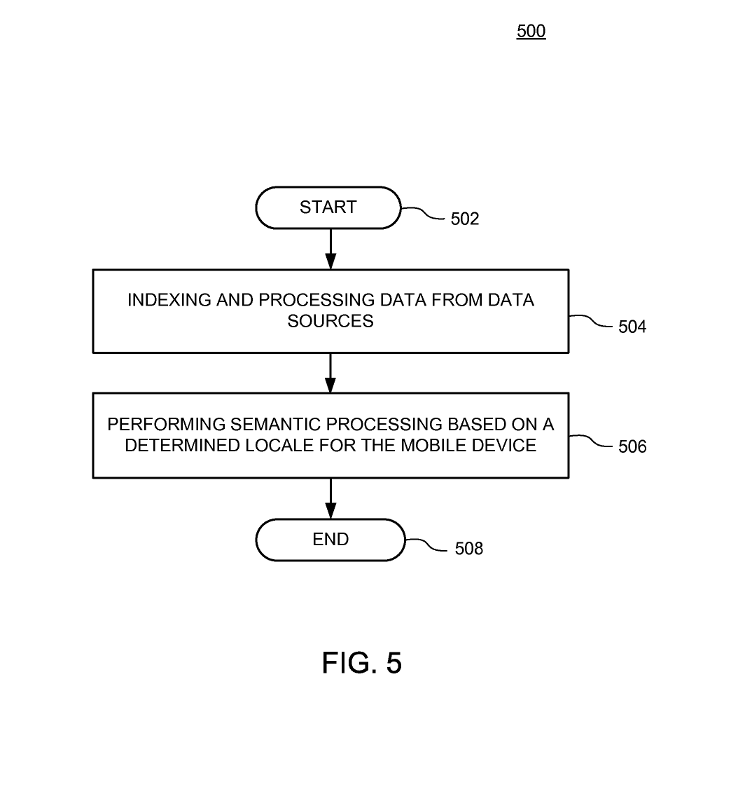

FIG. 5 depicts a flow diagram of a method 500 for processed data on a mobile device in accordance with exemplary embodiments of the present invention. The method 500 is an implementation of the indexing module 124 executed by the processor 102 of the computer 100. The method starts at step 502 and proceeds to step 504.

At step 504, the method 500 indexes data from data sources such as a mobile device, online data sources, and the like. As in method 201, the indexed data includes email data, contacts data, calendar data, call log data, text messages, and the like. The indexed data is easily searchable and linkable to application entries such as calendar entries. At step 506, the indexing module 124 performs semantic processing on the data. In some embodiments, the semantic processing is based on a determined locale for the mobile device. Items are tagged and annotated based on their information. Inferencing is performed to derive new facts and beliefs on the extracted entities and the items harvested based on semantic information. Data is then correlated, classified and clustering is executed on extracted entities from the data. This process is described in U.S. patent application Ser. No. 13/182,245 to Nitz.

The semantic processing at step 506 enables a number of analytics scenarios that can be used to pro-actively coach the user and/or for the user to self-coach. For example, the semantic processing may see that you spend a predetermined number of hours per week working and only so many hours per week doing family activities (according to extracted calendar data). The processing may pro-actively suggest activities or “free time” to block for “life balance” type events. In other examples, the method may suggest that you need to exercise more, suggest you need more time to do a particular activity, suggest having dinner with a particular person and the like.

Analytics are performed on an individual user to make suggestions as above (and could be correlated with other public information such as national Holidays, and the like). Analytics are also performed across groups to indicate other types of information, for example, if multiple employees at a user's company are attending a particular event, then the application enhancement module 109 may also suggest this event for the user. Analytics is also performed in aggregate by geographic location, role type, and globally across all users of the application enhancement module 109. The method ends at step 508.

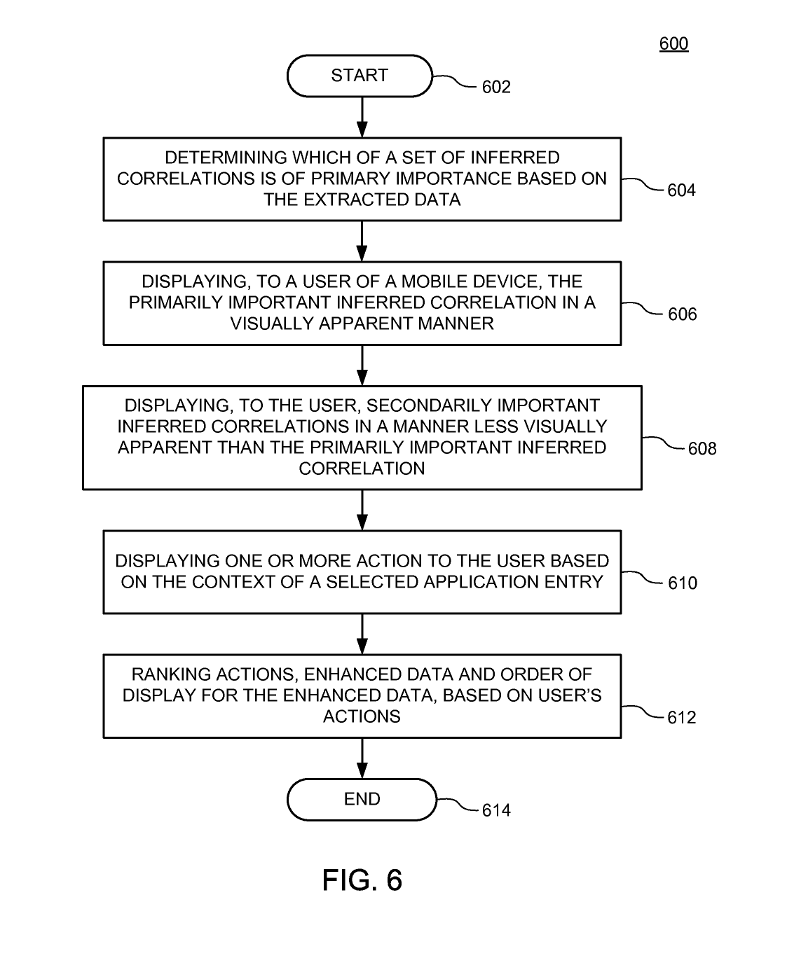

FIG. 6 depicts a flow diagram of the method 600 for determining primarily and secondarily important correlations on a mobile device in accordance with exemplary embodiments of the present invention. The method 600 is an implementation of the indexing module 124, the inference module 120 and the enhancement module 112 executed by the processor 102 of the computer 100. The method starts at step 602 and proceeds to step 604.

At step 604, the method 600 determines which of a set of inferred correlations is of primary importance based on the extracted data. For example, the method 600 may determine that a Starbucks® on Main Street is a likely destination meeting and also likely a one on one meeting versus a one to many meeting based on statistics regarding events at Starbucks®, or similar venues. In this instance, the method may decide that the primary information to display is the location of the Starbucks as inferred from an email and/or via public web sources based on the user's location/home-base and other signals. The secondary information may be the attendee's social networking details and contact information. At step 604, the intent of the meeting is also determined by the inference module 120. Common meeting intents include, but are not limited to, team meetings, manager meetings, dinner with friends, social events and common calendar task events like sending flowers, paying rent, taking out the trash and the like. Actions on these intents are influenced by the intent and the context; for example, Starbucks could yield contextual actions such as “Buy Coffee”. Additional information (phone number for reservations, reviews, nearby parking spots and the like) will also be provided to the user. Semantic dictionaries are built for each user and group and the dictionaries are transferred among different groups using a set of rules.

At step 606, the method 600 displays to a user of a mobile device, the primarily important inferred correlation in a visually apparent manner. For example, in the instance where the event is at a café, the method would display in a visually apparent manner, a “card” showing the location of the café along with other information about the café such as hours, menu and the like. If a café is not specified, a card may optionally be shown with nearby cafes or a particular café may be inferred based on previous meetings with a similar attendee list.

At step 608, the method 600 displays, to the user, secondarily important inferred correlations in a manner less visually apparent than the primarily important inferred correlation. The “card” for the secondarily important correlation will be in the background of the primarily important card, lower on the screen, on the side or the like. In one embodiment, each card contains different type of information such as location, attendees, conference calls, flights, related documents, related emails and so forth. Each suggested card is contextually inferred based on the intent of the meeting. For example, only a flight will display a related Flights card with actions to Check into the flight or view the status of the flight.

At step 610, the method 600 displays one or more action to the user based on the context of a selected application entry. For example, actions such as book a table on open table, order on-line, rate the venue, check-in via a mobile application, post to social networking site and the like, related to that type of event/venue will be displayed on the respective cards shown to the user. At step 612, the method optionally ranks the one or more actions based on the user's frequency of selection of an action in the one or more actions and may display them more prominently or more often for the user. Alternatively, the method 600 ranks the inferred correlations. The method 600 then ranks the one or more actions based on the user's frequency of selection of an action in the one or more actions and then displays, to the user, the inferred correlations according to the ranking of the inferred correlations and the one or more actions.

Actions are displayed based on user context and from inferred intent of the meeting, and the order of the actions may be influenced by learning about the user (eg actions he often uses or patterns of behavior seen over daily use of the calendar). In some instances, actions may be highlighted or pushed to the user—for example, if the user is running late to a meeting and the user is usually on time, a notification is triggered by the notification module 116 to awaken the device to notify the user, as shown in FIG. 2C, view 234. The method ends at step 614.

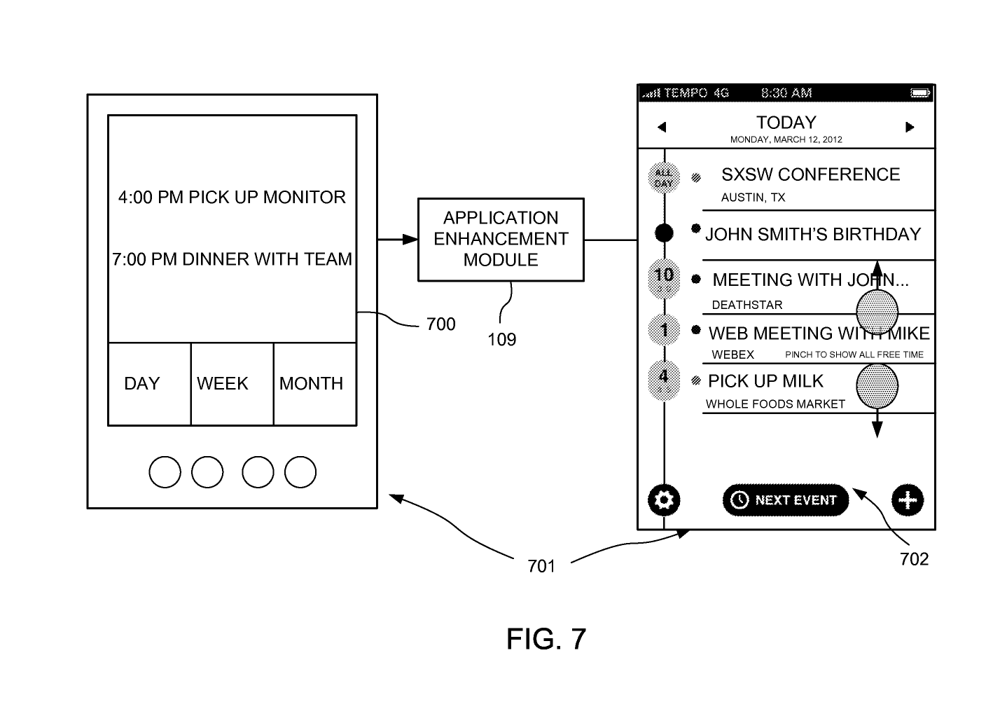

FIG. 7 is an illustration of the application enhancement module enhancing calendar data in accordance with exemplary embodiments of the present invention. The original calendar application 700 is shown in device 701. The view in 700 is a day view, however this is customizable through gestures or touch motions and month views, year views and the like can also be shown. The method can augment the view with additional information by identifying and signaling which meetings are personal, work, family or other, identify day events or conferences versus meetings, identify birthdays (via semantic processing only), identify conference calls versus destination meetings versus internal meetings, identify the approximate time to reach each meeting, identify other important events such as flights, trips, anniversaries, coffee meetings, identify which meetings are important and/or going to be useful, identify which meetings have been rescheduled, indicate which meetings have open action items, indicate which meetings may not require your attendance (based on semantic understanding), indicate which meetings may cause you stress, indicate which meetings you may need to prepare for, and the like.

The inferences are based, according to one embodiment, on data from the user, group, team, and/or historical data analysis of the user's personal calendar and other applications. According to one embodiment, the view in 700 color codes various entries according to their relevance, importance, privacy setting, availability and the like. The view in 700 may also semantically add drive times to locations, weather forecasts, and the like. According to another embodiment, suggested events are sourced from public event calendars/systems and/or by processing common events attended (or plan to be attended) by a user's colleagues or other users whose devices implement the application enhancement module 109 that are determined to be similar to the user.

Two calendar entries are shown by way of example. The application enhancement module 109 is applied to these calendar entries. Using contextually extracted data from the device 701 an enhanced application view 702 is shown on the device 701. View 702 contains inferred calendar entries based on the inferences of the inference module 120. View 702 is generated by the enhancement module 112 of the application enhancement module 109. The enhanced view 702 contains application entries but may also contain “cards” such as Location cards, Email cards, Contact cards and the like, as shown in FIG. 2D.

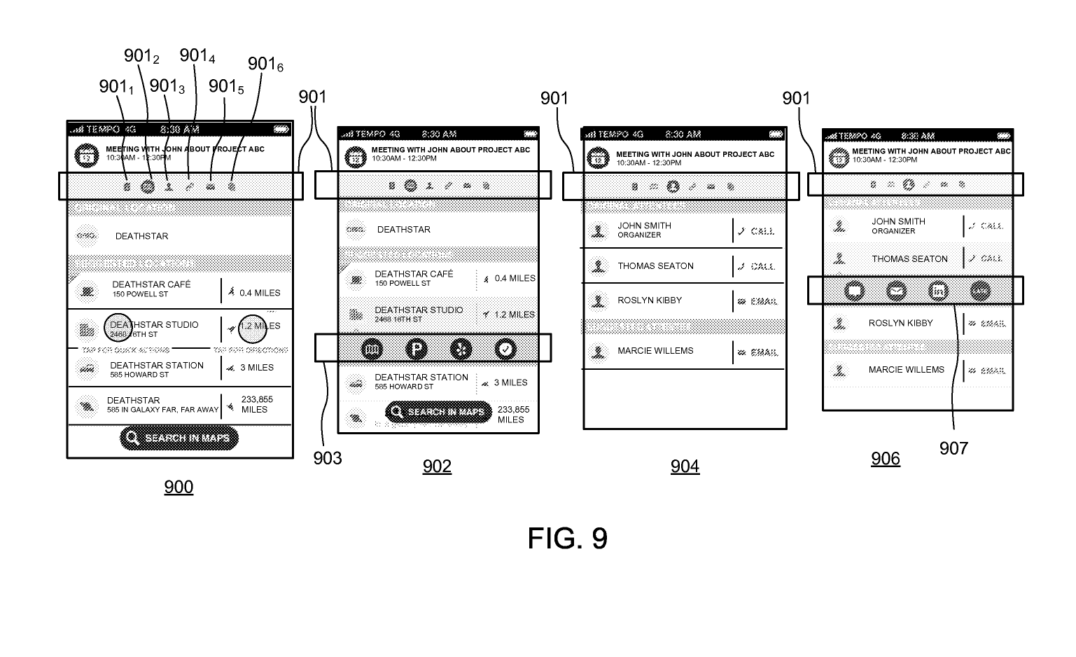

FIG. 9 is an illustration of a contextual and semantic action bar component 901 in a user interface of the computing device implementation of FIG. 1. Action bar 901 enables the user to perform actions on a particular card. In one embodiment, the action bar 901 provides several actions 901₁ to 901ₙ. In the shown embodiment, the action bar 901 displays actions 901₁ to 901₆. In the example shown, the user selects the location action 901₂ which prompts the display of location card in view 900. In view 900, the user has scheduled a meeting at the “Deathstar.” However, since the “Deathstar” is ambiguous, the card 900 displays several suggested locations from which to choose.

View 902 shows a second action bar 903 embedded in the location card Users are able to view the map for a particular location entry, search for parking, check-in at the location, amongst other actions provided, as well as user customizable actions. In view 904, the user selects the attendee's action 901₃, where all attendees of the meeting are shown in an attendee card. Though some actions are available on the card itself, as shown in view 906, a third action bar 907 is displayed when a user selects a particular attendee. The user can then chat, email, call, or perform similar actions with the selected user using the action bar 907.

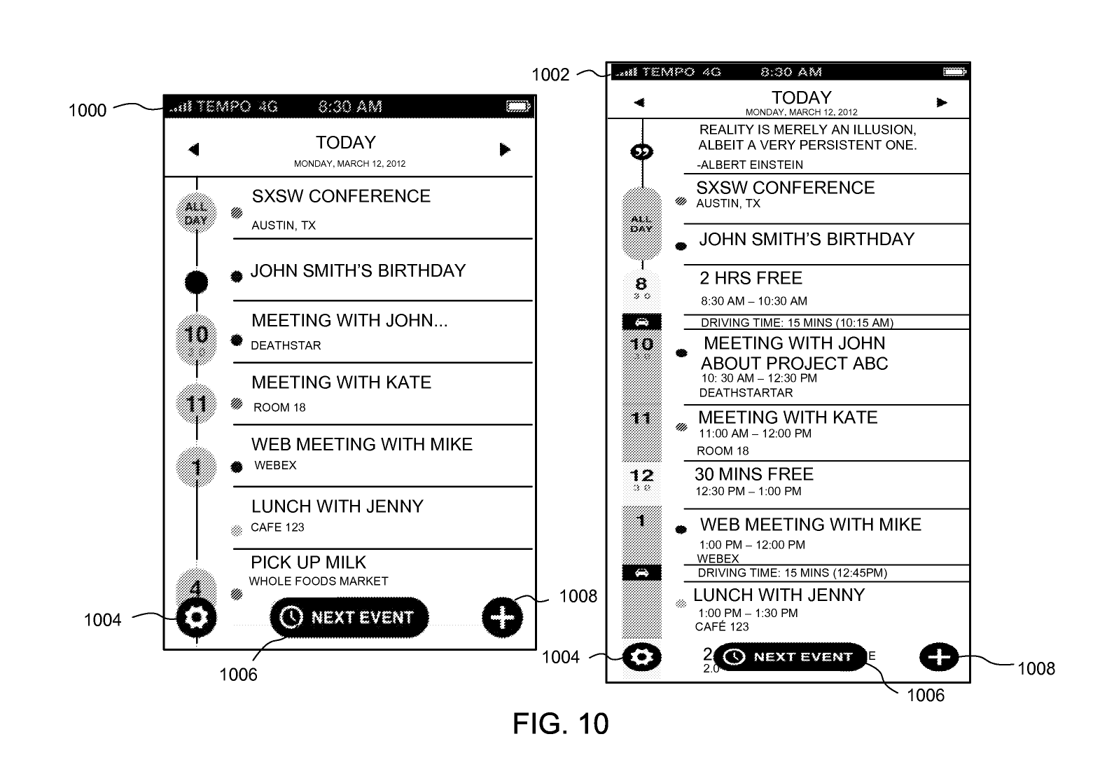

FIG. 10 is an illustration of overlapping day views 1000 and 1002 of the user interface in the computing device implementation of FIG. 1. View 1000 shows a typical day view presented to the user. The user has multiple meetings and events scheduled throughout the day which were extracted from a local or remote calendar or data source, some enhanced or created through the computer implementation 100 of FIG. 1. View 1004 also shows an example layout screen of the day view. In one embodiment, the day view in view 1000 or 1002 can be configured using the settings button 1004. If the user would like to move to the next event, the user can press the next event button 1006. If the user would like to add an event or meeting, the user can press button 1008. View 1002 shows an expanded overlapping day view for the user. According to some embodiments, this View could be initiated via a pinch gesture, effectively zooming in/out of the simpler View 1000. View 1002 gives a more detailed view of the user's meetings and events, for example, showing free time, travel time for a particular destination, or teleconference call information for a telephone conference.

As shown in FIG. 10, the application enhancement module 109 directs the presentation module 122 to display dynamically generated objects into the Day view 1002. For example, a “Quote of the Day” section is inserted in view 1002. The dynamically generated objects are based on a range of the signals mentioned previously and as inferred by the inference module 120.

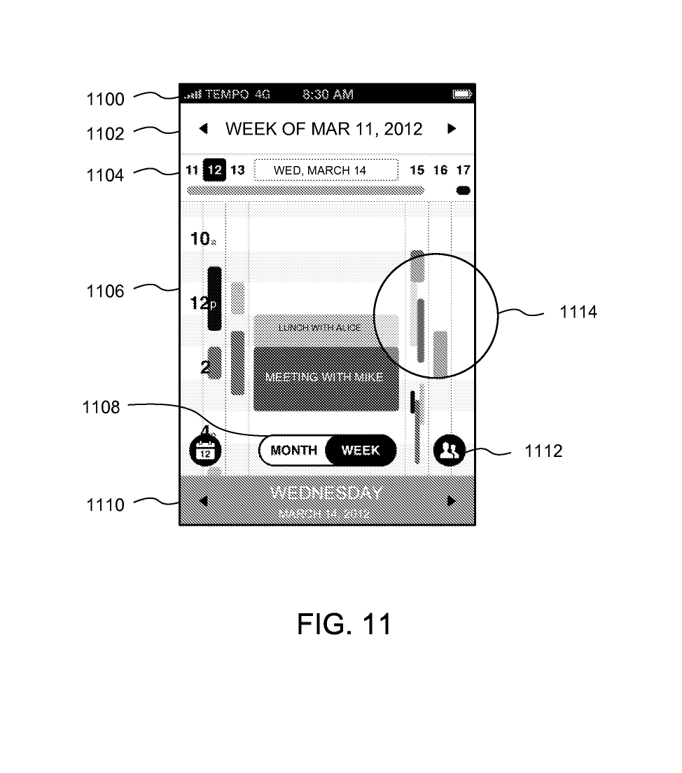

FIG. 11 is an illustration of an alternate week view 1100 of the user interface in the computing device implementation of FIG. 1. According to one embodiment, the week view 1100 comprises a week navigation portion 1102, a day navigation portion 1104, a meeting viewing portion 1106, a view toggle 1108, a day toggle 1110, an attendee button 1112 and spanning portions 1114. The week navigation portion 1102 enables the user to navigate between weeks. For example, a user may view meetings and events in the current week of Mar. 11, 2012, or move to the next week of Mar. 18, 2012. Similarly, the day navigation portion 1104 allows a user to switch the day with the most detail shown in section 1106. Days which are not in focus are shown as smaller slivers in the meeting viewing portion 1106 of the display. The attendee button 1112 allows a user to overlay other user's availability schedules on the user's device. With overlayed availability information, the user can view free meeting time slots amongst attendees of different organizations effectively enabling free, busy sharing.

The user is further able to toggle between a month and week view using view toggle 1108, and the user may toggle between days using the day toggle 1110. If the user is viewing a particular meeting, the user may view the attendees for the meeting by enabling the button 1112. Meetings and their overlapping portions are shown by the spanning portions 1114 shown in view 1100 as various shaded regions. The shaded regions represent the time span for various meetings throughout the week currently being viewed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A computer-implemented method for enhancing a calendar view on a device comprising:
extracting data from a user's linked data store;
processing the data to recognize one or more entities within the data
inferring correlations between the entities;
supplementing existing calendar entries on the user's device with the inferred correlations, creating new entities; and
displaying one or more actions to the user based on the context of a selected calendar entry.

2. The method of claim 1 further comprising:
determining one or more intents of calendar entries based on the inferred correlations to assist in supplementing the calendar entries; and
overlaying the supplemented calendar entries with the inferred entities in a calendar view.

3. The method of claim 2 wherein inferring correlations between the entities comprises:
inferring at least one of location, one or more attendees correlated to the calendar entries, related email and related documents.

4. The method of claim 3 further comprising:
collecting data regarding the calendar entries after the calendar entries scheduled time has passed.

5. The method of claim 3 further comprising sharing data between attendees and non-attendees correlated to the calendar entries.

6. The method of claim 1 further comprising:
executing a new calendar application showing enhanced calendar entries with the inferred entities and correlations;
displaying a contextual and personalized calendar view to the user;

7. The method of claim 6 further comprising:
updating the contextual view based on learning from the user, other users and groups of users.

8. The method of claim 6 further comprising:
updating the contextual view based on context wherein context corresponds to at least one of time of the day, whether the user is driving, whether the user is in motion, and whether the user is using the device.

9. The method of claim 1 further comprising:
notifying the user of modifications to the supplemented calendar entries.

10. The method of claim 1 wherein the extracting data further comprises indexing from other users and groups of users' data.

11. The method of claim 1 wherein the extracting data further comprises indexing the data from the device and external data sources.

12. The method of claim 11 wherein the indexed data comprises data from at least one of a calendar, a contacts list, email and documents.

13. The method of claim 11 further comprising semantic indexing based on at least one of a determined location for the device, and context wherein context corresponds to at least one of time of the day, whether the user is driving, and/or whether the user is using the device.

14. The method of claim 12 further comprising:
displaying one or more cards in the enhanced view relating to each of the entities or correlations, comprising one or more items of detail regarding each of the entities and one or more actions relating to the entities.

15. The method of claim 14 further comprising:
ranking the inferred correlations;
ranking the one or more actions based on the user's frequency of selection of an action in the one or more actions; and
displaying, to the user, the inferred correlations according to the ranking of the inferred correlations and the one or more actions.

16. The method of claim 1 wherein the extracted data further comprises at least one of time-stamped photographs for correlating with the application entries and time-stamped notes for correlating with the application entries.

17. The method of claim 1 further comprising:
determining the time of day; and
presenting the supplemented application entries to a user of the mobile device in an enhanced view of the application in a contextually coherent way according to the determined time of day.

18. The method of claim 1 further comprising:
determining which of the inferred correlations is of primary importance based on statistical modeling of the extracted data; and
displaying, to the user, the primarily important inferred correlation in a visually apparent manner.

19. The method of claim 1 wherein the actions comprise at least one of calling a number, launching an application, sharing details about a meeting, perform navigation, open user profile, and/or sending a textual communication regarding status.

20. An apparatus for enhancing a calendar view on a device comprising:
a data extraction module for extracting data from a user's linked data store;
an indexing module, coupled to the data extraction module, for processing the data to recognize one or more entities within the data;
an inference module, coupled to the indexing module, for inferring correlations between the entities;
an enhancement module, coupled to the inference module, for supplementing existing calendar entries on the user's device with the inferred correlations and entities, creating new entities; and
a presentation module for displaying one or more actions to the user based on the context of a selected calendar entry.
